(19) United States
(12) Patent Application Publication
(10) Pub. No.: US 2011/0257952 A1
(43) Pub. Date: Oct. 20, 2011

(54) METHOD FOR OPERATING AN INTERNAL COMBUSTION ENGINE HAVING A FEED LINE FOR FEEDING IN AN AIR MIXTURE AND HAVING AN EXHAUST LINE

(75) Inventors: Stefan Motz, Moeglingen (DE); Thomas Bossmeyer, Korntal-Muenchingen (DE)

(73) Assignee: ROBERT BOSCH GMBH, Stuttgart (DE)

(21) Appl. No.: 13/089,626

(22) Filed: Apr. 19, 2011

(30) Foreign Application Priority Data
Apr. 20, 2010 (DE) 10 2010 027 976.5

(51) Int. Cl. G06G 7/48; G06F 19/00; F02D 41/26; F02M 25/07; F02B 33/44

(52) U.S. Cl. 703/9; 123/568.11; 60/605.2; 701/102; 702/45

(57) ABSTRACT

A method for operating an internal combustion engine (10), the internal combustion engine (10) having a feed line (14) for feeding an air mixture into the internal combustion engine (10), the feed line (14) having a first section (27) at a comparatively low pressure, a compressor (22) for compressing the air mixture fed in, and a second section (29) at a comparatively high pressure arranged in series in the feed direction, the internal combustion engine (10) having an exhaust line (12) for discharging exhaust gas from the internal combustion engine (10), the exhaust line (12) having a section (43) in which the exhaust gas is at a comparatively low pressure, and the internal combustion engine (10) having an exhaust gas recirculation system (50) which recirculates into the first section (27) of the air feed (14) at least part of the exhaust gas which flows through the section (43) of the exhaust line (12) at the comparatively low pressure, the recirculated part of the exhaust gas and fresh air fed in forming the air mixture flowing through the feed line (14). A mass flow (71) of the recirculated part of the exhaust gas is determined by means of the following steps: (a) determination of a mass flow (72) flowing through the compressor (22); (b) determination of a mass flow (70) of the fresh air fed in; and (c) subtraction of the mass flow (70) determined in step (b) from the mass flow (72) determined in step (a).

### BACKGROUND OF THE INVENTION

The invention relates to operating an internal combustion engine, specifically to determining a mass flow or a recirculated part of an exhaust gas.

Exhaust gas recirculation systems for internal combustion engines, by means of which part of the exhaust gas produced by the internal combustion engine is recirculated into an inlet of the internal combustion engine, are known commercially. Here, a distinction is drawn between two methods: firstly, what is referred to as high-pressure exhaust gas recirculation, in which an outlet of the internal combustion engine is connected comparatively directly to the inlet of the internal combustion engine. Secondly, there is low-pressure exhaust gas recirculation, in which an exhaust gas flow downstream of an exhaust turbine is fed into a feed line of the internal combustion engine upstream of the compressor. Low-pressure exhaust gas recirculation of this kind may be suitable for compliance even with future exhaust regulations. Closed-loop control of the mass flow in the low-pressure exhaust gas recirculation system is of corresponding significance in that regard.

Calculation of a low-pressure exhaust gas recirculation rate requires not only a fresh air mass flow but also the mass flow in the low-pressure exhaust gas recirculation system. In motor vehicles, the fresh air mass flow is often measured by means of a sensor, i.e. with an air mass meter. By contrast, the mass flow in the exhaust gas recirculation system is not measured directly but merely estimated by means of various methods or models. For example, the mass flow through a valve arranged in the low-pressure exhaust gas recirculation system can be calculated by means of what is referred to as a restriction equation. For this purpose, it is necessary to know a throttle area, a temperature ahead of the valve and a pressure ahead of and after the valve. The throttle area is often not determined directly but is determined, for example, from the position of a flap which influences the valve cross section. However, it is often not possible to detect the position of this flap with sufficient accuracy and, furthermore, the effective aperture cross section depends on flow-related variables. Moreover, additional inaccuracies in measurement can occur.

Patent publications from this specialist area include DE 101 58 250 A1, for example, which describes a method for determining a mass flow flowing through a compressor.

### SUMMARY OF THE INVENTION

Features of the invention can be found in the description below and in the drawing, and the features may be used both in isolation and also in different combinations, even if no further explicit reference is made thereto.

The invention has the advantage that a mass flow in a low-pressure exhaust gas recirculation system can be determined in a particularly accurate way. This in turn ensures that the operation of the internal combustion engine can be adjusted in a particularly effective way in order, for example, to optimize exhaust emissions, fuel consumption and/or noise occurring in operation.

The invention starts from the consideration that the mass flow in a low-pressure exhaust gas recirculation system need not be detected or determined directly but can be calculated from other variables. Starting from a specific design of an internal combustion engine, fresh air induced is therefore combined with the recirculated exhaust gas and fed to a compressor. On this basis, it is possible to specify an equation for determining the mass flow in the low-pressure exhaust gas recirculation system as follows:

\dot{m}_{LP-EGR}=\dot{m}_{compressor}−\dot{m}_{fresh air}, where

LP-EGR=low-pressure exhaust gas recirculation system

This formula means that a mass flow flowing through the compressor is determined, that furthermore a mass flow of the fresh air fed in is determined and, finally, that the mass flow of fresh air fed in is subtracted from the mass flow flowing through the compressor. This results in particularly simple and, at the same time, accurate determination of the mass flow in the low-pressure exhaust gas recirculation system.

As a preferred option, the invention envisages that the mass flow flowing through the compressor be determined by means of a model. The advantage of this is that it is possible to determine the mass flow through the compressor on the basis of a number of variables that are frequently already available in a control unit of the internal combustion engine.

In particular, provision is made for the model to evaluate at least one of the following variables: a rotational speed of the compressor, a pressure ahead of the compressor, a pressure after the compressor, a temperature ahead of the compressor, a temperature after the compressor. In this context, the term “ahead of” means “upstream” and the term “after” means “downstream”. These variables are particularly suitable for accurately determining the mass flow through the compressor. The rotational speed of the compressor, in particular, is decisive for the magnitude of the mass flow through the compressor. In certain cases, it may be sufficient to use just some of the variables described to model the mass flow through the compressor. However, it is also possible to make use of additional variables that are available during the operation of an internal combustion engine, though they are not mentioned here, in order to determine the mass flow flowing through the compressor with even greater accuracy.

As an additional measure, the invention envisages or allows for arrangement of an exhaust turbine, an oxidation catalyst and/or a particulate filter upstream of the section of the exhaust line at the comparatively low pressure. In particular, the exhaust turbine separates a zone where the exhaust gas is at a comparatively high pressure from a zone where the exhaust gas is at a comparatively low pressure. This advantageously enables the method to be applied to a frequently encountered embodiment of an exhaust line for the internal combustion engine, such an embodiment being used with diesel engines, for example. The particular order in which the exhaust turbine, the oxidation catalyst and/or the particulate filter occur in the direction of flow in the exhaust line is irrelevant to the method according to the invention.

It is particularly advantageous for the application of the method if the compressor is driven by the exhaust turbine. This advantageously enables an exhaust turbine speed sensor to be used to determine a rotational speed of the compressor.

One embodiment of the method envisages that the mass flow of the recirculated part of the exhaust gas can be subjected to open-loop and/or closed-loop control. Open-loop and/or closed-loop control of the recirculated part of the exhaust gas allows particularly effective adjustment of the operation of the internal combustion engine, with respect to fuel consumption or exhaust emissions for example. The determination of the mass flow in the low-pressure exhaust gas recirculation system, which is particularly accurate according to the invention, can thus be used to advantage to adjust the operation of the internal combustion engine with corresponding accuracy.

According to another proposal, the mass flow of the fresh air fed into the feed line is determined by means of an air mass meter. Using a hot-film air mass meter, the mass flow of the fresh air fed in can be determined in a simple and accurate manner. The subtrahend for the abovementioned formula is thereby determined at the same time.

Another embodiment of the invention allows for the exhaust line to have a section at a comparatively high pressure, and for the internal combustion engine to have a further exhaust gas recirculation system, which is arranged between said section of the exhaust line at the comparatively high pressure and the second section of the feed line at the comparatively high pressure. Determination of the mass flow of the recirculated part of the exhaust gas in the low-pressure exhaust gas recirculation system as specified by the invention is therefore suitable for combination with an additional exhaust gas recirculation system in a high-pressure branch of the exhaust system. The low-pressure exhaust gas recirculation system or, more specifically, the determination in accordance with the invention of the exhaust gas mass flow recirculated in the low-pressure exhaust gas recirculation system can therefore be combined in an advantageous manner with a high-pressure exhaust gas recirculation system of the internal combustion engine.

It may additionally be observed that the method according to the invention can be employed even when the proportion of exhaust gas recirculated in the exhaust gas recirculation system does not admit of open-loop and/or closed-loop control but when, as an alternative, open-loop and/or closed-loop control of the mass flow of the fresh air fed in is performed by means of a fresh air throttle. The method can likewise be applied to internal combustion engines provided with single-stage or two-stage pressure charging and to charger groups comprising fixed chargers rather than chargers with variable turbine geometry, and likewise where there are bypasses installed in the exhaust line or in the air feed. The invention also works both with petrol and diesel engines and with natural gas engines, and can also be used whether or not the exhaust turbine, the oxidation catalyst and/or the particulate filter are present and irrespective of the embodiment thereof.

### BRIEF DESCRIPTION OF THE DRAWINGS

An illustrative embodiment of the invention is explained below with reference to the drawing. In the drawing:

FIG. 1 shows a schematic representation of an illustrative embodiment of an internal combustion engine with a feed line for feeding in an air mixture and with an exhaust line.

### DETAILED DESCRIPTION

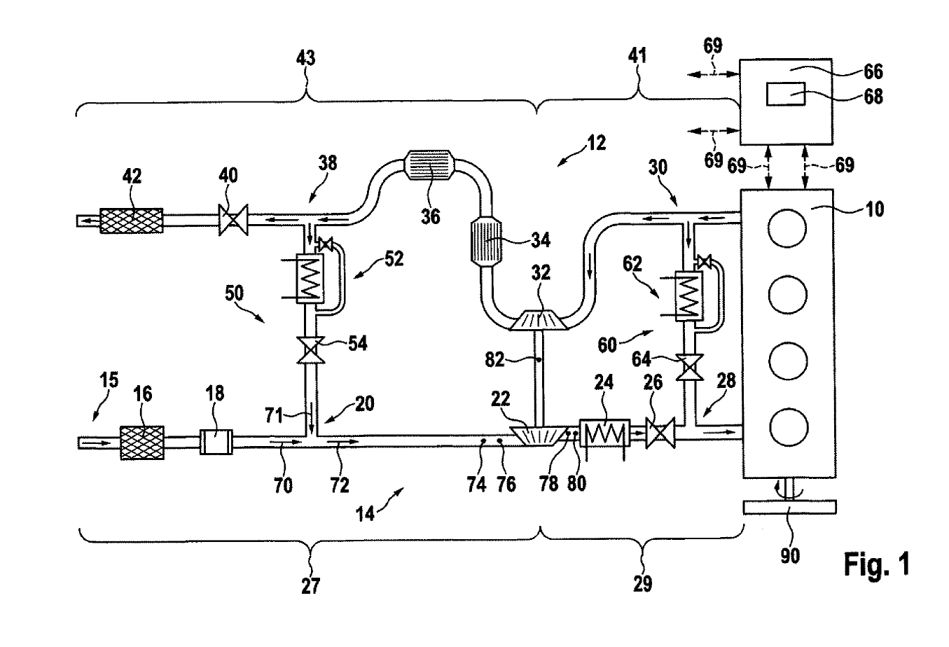

FIG. 1 shows an internal combustion engine 10 with an exhaust line 12 and a feed line 14 for feeding an air mixture into the internal combustion engine 10. Working from left to right in the drawing, the feed line 14 contains: an air inlet 15, an air filter 16, a hot-film air mass meter 18, a branch 20, a compressor 22, a cooler 24, a valve 26 and a branch 28. Here, an air path from the air inlet 15 to the compressor 22 constitutes a first section 27 at a comparatively low pressure, and an air path from the compressor 22 to the internal combustion engine 10 constitutes a second section 29 at a comparatively high pressure.

Working from right to left in the drawing, the exhaust line 12 in the upper area of FIG. 1 contains: a branch 30, an exhaust turbine 32, an oxidation catalyst 34, a particulate filter 36, a branch 38, a valve 40 and a silencer 42. Here, an exhaust path from the internal combustion engine 10 to the exhaust turbine 32 constitutes a section 41 at a comparatively high pressure, and an exhaust path from the exhaust turbine 32 to the silencer 42 constitutes a section 43 at a comparatively low pressure. It is obvious that the pressure along section 43 can also be reduced in steps by way of the exhaust turbine 32, the oxidation catalyst 34 and the particulate filter 36 according to the flow resistance occurring in said elements.

In the left-hand area of FIG. 1, there is a low-pressure exhaust gas recirculation system 50 between the branch 38 in the exhaust line 12 and the branch 20 in the air feed 14. The low-pressure exhaust gas recirculation system 50 comprises a device 52 and a valve 54.

In the right-hand area of FIG. 1, there is a high-pressure exhaust gas recirculation system 60 between the branch 30 in the exhaust line 12 and the branch 28 in the air feed 14. The high-pressure exhaust gas recirculation system 60 comprises a device 62 and a valve 64. In the present case, devices 52 and 62 each comprise an exhaust gas recirculation cooler with a bypass and a valve, which is not explained in greater detail.

A control unit 66 together with a computer program 68 running thereon is shown schematically at the top right in the drawing. Arrows 69 symbolize the electrical connection of the control unit 66 to the elements indicated in FIG. 1. The control unit 66 and the computer program 68 furthermore contain at least one model for calculating a mass flow flowing through the compressor 22.

During operation, a mass flow 70 of fresh air fed in is determined by the hot-film air mass meter 18. Together with the mass flow 70, a mass flow 71 of the exhaust gas recirculated via the low-pressure exhaust gas recirculation system 50 forms a mass flow 72, which is passed through the compressor 22. A pressure 74 and a temperature 76 are determined ahead of the compressor 22. A pressure 78 and a temperature 80 are determined after the compressor 22. The compressor 22 is coupled rigidly to the exhaust turbine 32 and has a rotational speed 82.

The values for the pressure 74 and the temperature 76, which are determined directly upstream of the compressor 22, the values for the pressure 78 and the temperature 80, which are determined directly downstream of the compressor 22, and the rotational speed 82 of the compressor 22 make it possible to carry out accurate determination of the mass flow 72 flowing via the compressor 22 by means of the model in the control unit 66. Attention is drawn to the fact that not all the variables mentioned above may be required to determine the mass flow 72 flowing via the compressor 22 but that, in certain circumstances, some of these variables may be sufficient in combination with the model to perform sufficiently accurate determination of said mass flow 72.

In accordance with the value for the mass flow 70 determined by means of the hot-film air mass meter 18, the mass flow 71 of the exhaust gas flowing via the low-pressure exhaust gas recirculation system 50 can now be determined by simple difference formation. As a result of the comparatively high accuracy with which the mass flows 70 and 72 are determined, the determination thus effected of the mass flow 71 is also particularly accurate. Valve 54 and/or valve 40 can therefore be adjusted or controlled in an optimum manner for optimization of the operation of the exhaust line 12 and of the internal combustion engine 10.

In addition, it is conceivable, if required, to correct the value for the mass flow 70 determined by the hot-film air mass meter 18 in order to compensate for pressure fluctuations in the feed line 14, for example. It may furthermore be gathered from FIG. 1 that determination of the mass flow 71 is largely decoupled from the operation of the high-pressure exhaust gas recirculation system 60.

1. A method for operating an internal combustion engine (10), the internal combustion engine (10) having a feed line (14) for feeding an air mixture into the internal combustion engine (10), the feed line (14) having a first section (27) at a comparatively low pressure, a compressor (22) for compressing the air mixture fed in, and a second section (29) at a comparatively high pressure arranged in series in the feed direction, the internal combustion engine (10) having an exhaust line (12) for discharging exhaust gas from the internal combustion engine (10), the exhaust line (12) having a section (43) in which the exhaust gas is at a comparatively low pressure, and the internal combustion engine (10) having an exhaust gas recirculation system (50) which recirculates into the first section (27) of the air feed (14) at least part of the exhaust gas which flows through the section (43) of the exhaust line (12) at the comparatively low pressure, and the recirculated part of the exhaust gas and fresh air fed in forming the air mixture flowing through the feed line (14), characterized in that a first mass flow (71) of the recirculated part of the exhaust gas is determined by means of the following steps:
(a) determining a second mass flow (72) flowing through the compressor (22);
(b) determining a third mass flow (70) of the fresh air fed in; and
(c) determining the first mass flow (71) by subtracting the third mass flow (70) determined in step (b) from the second mass flow (72) determined in step (a).

2. A method according to claim 1, characterized in that the second mass flow (72) flowing through the compressor (22) is determined by means of a model.

3. A method according to claim 2, characterized in that the model evaluates at least one of the following variables:
a rotational speed (82) of the compressor (22);
a first pressure (74) ahead of the compressor (22);
a second pressure (78) after the compressor (22);
a first temperature (76) ahead of the compressor (22);
a second temperature (80) after the compressor (22).

4. A method according to claim 2, characterized in that the model evaluates a rotational speed (82) of the compressor (22).

5. A method according to claim 2, characterized in that the model evaluates a pressure (74) ahead of the compressor (22).

6. A method according to claim 2, characterized in that the model evaluates a pressure (78) after the compressor (22);

7. A method according to claim 2, characterized in that the model evaluates a temperature (76) ahead of the compressor (22);

8. A method according to claim 2, characterized in that the model evaluates a temperature (80) after the compressor (22).

9. A method according to claim 1, characterized in that an exhaust turbine (32), an oxidation catalyst (34), and a particulate filter (36) are arranged upstream of the section (43) of the exhaust line (12) at the comparatively low pressure.

10. A method according to claim 9, characterized in that the compressor (22) is driven by the exhaust turbine (32).

11. A method according to claim 1, characterized in that an exhaust turbine (32) is arranged upstream of the section (43) of the exhaust line (12) at the comparatively low pressure.

12. A method according to claim 1, characterized in that an oxidation catalyst (34) is arranged upstream of the section (43) of the exhaust line (12) at the comparatively low pressure.

13. A method according to claim 1, characterized in that a particulate filter (36) is arranged upstream of the section (43) of the exhaust line (12) at the comparatively low pressure.

14. A method according to claim 1, characterized in that the first mass flow (71) of the recirculated part of the exhaust gas is subjected to open-loop and closed-loop control.

15. A method according to claim 1, characterized in that the first mass flow (71) of the recirculated part of the exhaust gas is subjected to open-loop control.

16. A method according to claim 1, characterized in that the first mass flow (71) of the recirculated part of the exhaust gas is subjected to closed-loop control.

17. A method according to claim 1, characterized in that the mass flow (70) of the fresh air fed into the feed line (14) is determined by means of an air mass meter (18).

18. A method according to claim 1, characterized in that the exhaust line (12) has a section (41) at a comparatively high pressure, and in that the internal combustion engine (10) has a further exhaust gas recirculation system (60), which is arranged between said section (41) of the exhaust line (12) at the comparatively high pressure and the second section (29) of the feed line (14) at the comparatively high pressure.

19. A computer program (68) for a digital computing element for carrying out a method of
(a) determining a first mass flow (72) flowing through a compressor (22);
(b) determining a second mass flow (70) of fresh air fed in to an internal combustion engine (10) through a feed line (14); and
(c) determining the third mass flow (71) of a recirculated part of an exhaust gas by subtracting the second mass flow (70) determined in step (b) from the first mass flow (72) determined in step (a).

20. A control unit (66), for a motor vehicle, which is provided with a digital computing element, on which a computer program (68) is run for carrying out a method of
(a) determining a first mass flow (72) flowing through a compressor (22);
(b) determining a second mass flow (70) of fresh air fed in to an internal combustion engine (10) through a feed line (14); and
(c) determining the third mass flow (71) of a recirculated part of an exhaust gas by subtracting the second mass flow (70) determined in step (b) from the first mass flow (72) determined in step (a).
